(19) United States
(12) Patent Application Publication
(10) Pub. No.: US 2024/0371344 A1
(43) Pub. Date: Nov. 7, 2024

(54) PISTON FOR WIND INSTRUMENTS

(71) Applicant: Conn-Selmer, Inc., Elkhart, IN (US)

(72) Inventor: Gavin O`Toole Brehm, Chicago, IL (US)

(21) Appl. No.: 18/142,360

(22) Filed: May 2, 2023

(51) Int. Cl. G10D 7/10

(52) U.S. Cl. CPC G10D 7/10

(57) ABSTRACT

A piston for a wind instrument includes a one-piece body, the one-piece body defining a plurality of ports and one or more windways each connecting at least a subset of the plurality of ports. The plurality of ports and the one or more windways are formed by processing a single piece of a material to remove a portion of the material from the single piece. The single piece of the material can be a cylindrical rod of the material. The one-piece body can be made of aluminum, an aluminum alloy, brass, a nickel-copper alloy, or stainless steel. The surface of the piston can be hard coat anodized and/or polytetrafluoroethylene (PTFE) sealed.

### TECHNICAL FIELD

This specification relates to wind instruments, and in particular, wind instruments that include pistons (e.g., for use in a piston valve).

### BACKGROUND

Wind instruments (e.g., brass instruments, woodwind instruments, etc.) are instruments that produce sound as air moves through the instrument. For example, sound can be produced by a user blowing air through one or more tubes (or “airways”) of the wind instrument, causing the air to vibrate at a resonant frequency. Many wind instruments include mechanisms such as rotary valves or piston valves that are movable by a user of the wind instrument to alter the flow of air within the instrument, for example, to change a pitch or sound quality of the produced sound. Piston valves typically include a piston disposed within a valve casing. The piston can include one or more ports connected by windways. As the piston moves within the valve casing, at least some of the ports of the piston can align with openings in the side wall of the valve casing, which can in turn be aligned with at least some of the tubes of the wind instrument. In this manner, movement of the piston within the valve casing can alter the flow of air within the wind instrument to change a pitch or quality of sound produced by the instrument.

### SUMMARY

Pistons used in wind instruments can be difficult to manufacture using existing methods, which can involve many starting components (e.g., over 15 components, over 20 components, over 25 components, over 30 components, etc.) and many manufacturing steps (e.g., over 50 steps, over 60 steps, over 75 steps, over 80 steps, etc.). The complexity of existing manufacturing methods, which are further described below, can require substantial amounts of skilled manual labor and high costs (e.g., for materials and for labor). Furthermore, the complexity of existing methods for manufacturing pistons for wind instruments can result in low yields of usable pistons due to, e.g., long manufacturing times and the substantial potential for the introduction of human-attributable mistakes and imperfections in the manufacturing process.

The technology described herein includes pistons for wind instruments, wind instruments that include pistons, and methods of manufacturing pistons that have various advantages over existing technologies. For example, by manufacturing pistons from a single piece of starting material (e.g., a solid rod of aluminum or an aluminum alloy, a brass rod, a nickel-copper alloy rod, a stainless steel rod, etc.), the number of starting components and manufacturing steps can be substantially reduced compared to existing processes. In addition, the use of a solid rod of material can have the advantage of enabling pistons to be machined using computer numerical control (CNC) machines (e.g., a 5-axis CNC machine) and grinding (e.g., centerless grinding). The ability to machine one-piece pistons using CNC machines and grinding can substantially reduce manufacturing times, can reduce the risk of introducing human-attributable errors and imperfections into the manufacturing process, can improve the reproducibility of manufactured pistons, and can increase the dimensional precision of manufactured pistons (e.g., to improve the fit of the piston within the valve casing of an instrument, to improve a seal between ports of the piston and airways of the instrument, etc.). The use of CNC machines and/or grinding can also yield structures having geometries, surface roughness, and materials that are unachievable using other conceivable manufacturing techniques for one-piece pistons such as certain additive manufacturing processes.

While aluminum or aluminum alloy pistons have not traditionally been used in brass instruments due, at least in part, to concerns about corrosion, the technology described herein can overcome such concerns. For example, a surface of the piston can be treated using hard coat anodization to create a harder, wear-resistant, corrosion-inhibiting surface for the piston. This can be advantageous for settings in which an aluminum or aluminum alloy piston acts as journal bearing against a brass housing (e.g., a brass valve casing). The surface of the piston can also be treated by polytetrafluoroethylene (PTFE) (e.g., Teflon) sealing to provide self-lubrication and to seal off pores on the surface of the piston. By incorporating surface treatment steps into the manufacturing process, the technology described herein can enable pistons to be manufactured from aluminum (or an aluminum alloy), which can be much less dense than traditionally-used materials such as nickel silver alloys (e.g., Monel, Inconel, Wieland-N31), stainless steel (e.g., 304 stainless steel), or nickel-or chrome-plated brass. The lower density of aluminum can in turn enable manufacturing pistons from a single piece of starting material (e.g., using a CNC machine), which would typically result in an undesirably heavy piston if implemented using denser materials such as nickel silver alloys, stainless steel, or brass.

Another advantage of the technology described herein is the inclusion of venting features in the piston, which can smooth changes to an air pressure within one or more airways of the wind instrument as the piston moves within the valve casing of the instrument. These venting features can prevent the build-up and sudden release of pressure as the piston moves within the valve casing, thereby improving the user experience, or “feel,” for a user of the instrument. In some implementations, the venting features can be removed from the same piece of starting material used for the rest of the piston, for example, using a CNC machine, thereby providing many of the same benefits as described above.

Yet another advantage of the technology described herein is that the piston can be interchangeable with existing pistons used in wind instruments. For example, the piston can be manufactured with dimensions and/or a weights similar to the dimensions and/or weights of existing pistons. This can enable the interchangeability of the pistons described herein with other existing pistons without substantially affecting a user's experience while playing the instrument and/or altering the sounds produced by the instrument.

In one aspect, a method for making a piston for a wind instrument is featured. The method includes removing a first portion of material from a single piece of the material to form a plurality of ports and one or more windways each connecting at least a subset of the plurality of ports.

Implementations can include the examples described below and herein elsewhere. In some implementations, the single piece of the material can include a cylindrical rod of the material. In some implementations, the material can include aluminum, an aluminum alloy, brass, a nickel-copper alloy, or stainless steel. In some implementations, the method can include hard coat anodizing a surface of the piston. In some implementations, the method can include polytetrafluoroethylene (PTFE) sealing a surface of the piston. In some implementations, removing the first portion of material from the single piece of the material can include removing the first portion of material from the single piece of the material using a computer numerical control (CNC) machine. In some implementations, the method can include removing a second portion of material from the single piece of material to form one or more venting features configured to smooth changes to an air pressure within one or more airways of the wind instrument as the piston moves within a casing of the wind instrument. In some implementations, the method can include drilling one or more mounting holes into a top surface of the piston. In some implementations, the method can include removing a second portion of material from the single piece of material to form a recessed feature configured to receive a spring. In some implementations, the method can include grinding an outer surface of the single piece of the material using a centerless grinder.

In another aspect, a piston for a wind instrument is featured. The piston includes a one-piece body, the one-piece body defining a plurality of ports and one or more windways each connecting at least a subset of the plurality of ports. The plurality of ports and the one or more windways are formed by processing a single piece of a material to remove a portion of the material from the single piece.

Implementations can include the examples described below and herein elsewhere. In some implementations, the single piece of the material can include a cylindrical rod of the material. In some implementations, the one-piece body can be made of aluminum, an aluminum alloy, brass, a nickel-copper alloy, or stainless steel. In some implementations, a surface of the piston can be hard coat anodized. In some implementations, a surface of the piston can be polytetrafluoroethylene (PTFE) sealed. In some implementations, processing the single piece of the material to remove the portion of the material from the single piece can include removing the portion of the material using a computer numerical control (CNC) machine. In some implementations, the piston can be configured to fit within a casing of the wind instrument and can be further configured to move translationally along a longitudinal axis of the casing when fit within the casing. In some implementations, the piston can include one or more venting features configured to smooth changes to an air pressure within one or more airways of the wind instrument as the piston moves translationally along the longitudinal axis of the casing. In some implementations, the one-piece body can define the one or more venting features. In some implementations, the wind instrument can be a trumpet, a French horn, a tuba, a euphonium, a cornet, a flugelhorn, a mellophone, a trombone, a valve trombone, a baritone, a marching brass instrument, a sousaphone, a piccolo trumpet, or a novel valved brass instrument. In some implementations, the piston can include a substantially flat top surface, wherein the top surface includes one or more mounting holes. In some implementations, the piston can include a bottom surface that includes a recessed feature configured to receive a spring.

In another aspect, a wind instrument is featured. The wind instrument includes one or more tubes configured to transport air moved by a user of the wind instrument; a valve casing, wherein a side wall of the valve casing includes one or more openings aligned with the one or more tubes; and a piston disposed within the valve casing. The piston includes a one-piece body, the one-piece body defining a plurality of ports, and one or more windways each connecting at least a subset of the plurality of ports. The plurality of ports and the one or more windways are formed by processing a single piece of a material to remove a portion of the material from the single piece.

Implementations can include the examples described below and herein elsewhere. In some implementations, the single piece of the material can include a cylindrical rod of the material. In some implementations, the one-piece body can be made of aluminum, an aluminum alloy, brass, a nickel-copper alloy, or stainless steel. In some implementations, a surface of the piston can be hard coat anodized. In some implementations, a surface of the piston can be polytetrafluoroethylene (PTFE) sealed. In some implementations, processing the single piece of the material to remove the portion of the material from the single piece can include removing the portion of the material using a computer numerical control (CNC) machine. In some implementations, the piston can be configured to move translationally along a longitudinal axis of the valve casing to align one or more ports of the plurality of ports with the one or more openings of the side wall of the valve casing. In some implementations, the piston can include one or more venting features configured to smooth changes to an air pressure within the one or more tubes as the piston moves translationally along the longitudinal axis of the valve casing. In some implementations, the one-piece body can define the one or more venting features. In some implementations, the wind instrument can be a trumpet, a French horn, a tuba, a euphonium, a cornet, a flugelhorn, a mellophone, a trombone, a valve trombone, a baritone, a marching brass instrument, a sousaphone, a piccolo trumpet, or a novel valved brass instrument. In some implementations, the piston can include a substantially flat top surface, wherein the top surface includes one or more mounting holes. In some implementations, the piston can include a bottom surface that includes a recessed feature configured to receive a spring.

Other features and advantages of the description will become apparent from the following description, and from the claims. Unless otherwise defined, the technical and scientific terms used herein have the same meaning as commonly understood by one of ordinary skill in the art to which this invention belongs.

### BRIEF DESCRIPTION OF THE DRAWINGS

FIG. 1 shows a perspective view of a wind instrument and a magnified diagram of a piston valve assembly.

FIGS. 2-3 show front perspective views of a piston.

FIG. 4 shows a top view of a piston.

FIG. 5 shows a bottom view of a piston.

FIG. 6A shows a front view of a piston.

FIG. 6B shows a cross-sectional front view of a piston.

FIG. 7A shows a right side view of a piston.

FIG. 7B shows a cross-sectional side view of a piston.

FIG. 8 shows a back view of a piston.

FIG. 9 shows a left side view of a piston.

FIGS. 10-11 show rear perspective views of a piston.

FIG. 12 is a flowchart of a process for making a piston.

FIG. 13 is a flowchart of a sub-process for making a piston.

### DETAILED DESCRIPTION

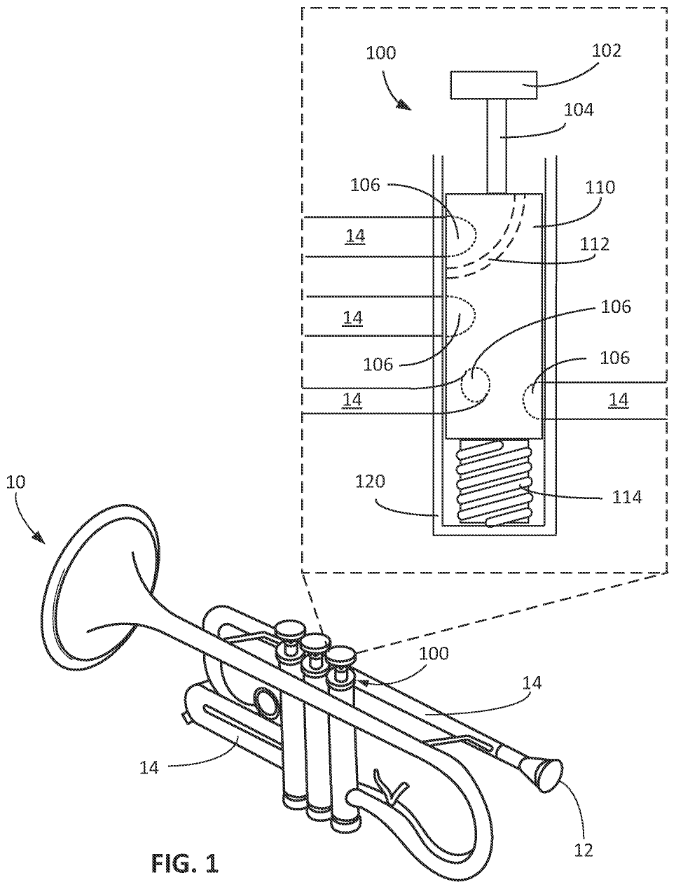

FIG. 1 illustrates a wind instrument 10 and a magnified diagram of a piston valve assembly 100. While the wind instrument 10 is depicted as a trumpet, the wind instrument 10 can be any instrument that may include piston valves. For example, the wind instrument could be a trumpet, a tuba, a euphonium, a sousaphone, etc. The wind instrument 10 includes a mouthpiece 12 (or other opening) through which a user can blow air through the wind instrument 10 (e.g., to generate a standing wave in the air column within the wind instrument). The wind instrument 10 also includes one or more tubes (or “airways”) 14 through which air (e.g., the air blown by the user) can travel. As air travels through the tubes 14 of the instrument 10, the air can reach a piston valve assembly 100 of the instrument 10, which can be operable by a user of the instrument 10 to change a pitch or quality of sound produced by the instrument 10.

The piston valve assembly 100 is an example implementation of a piston valve assembly used in wind instruments. However, it is not intended to be limiting, and other implementations of piston valve assemblies are contemplated. The piston valve assembly 100 includes a piston 110 that is configured to fit within a valve casing 120 of the instrument 10. For example, the piston 110 and the inner surface of the valve casing 120 can both be substantially cylindrical in shape, and an outer diameter of the piston 110 can be substantially similar to an inner diameter of the valve casing 120 (e.g., less than 0.01 inches different, less than 0.001 inches different, less than 0.0005 inches different, etc.). In such implementations, the outer surface of the piston 110 and the inner surface of the valve casing 120 can form a journal bearing.

The piston 110 can move translationally within the valve casing 120 along a longitudinal axis of the valve casing (e.g., up and down as shown in FIG. 1). A valve stem 103 and a valve button 102 can be mounted onto (e.g., screwed into, welded onto, adhered to, etc.) a top surface of the piston 110, allowing a user of the instrument 10 to push the piston 110 downward within the valve casing 120. The piston valve assembly 100 also includes a spring 114 to restore the piston 110 to a starting position (e.g., a position of static equilibrium) when the piston 110 is not being pushed downward by a user.

The piston 110 includes a plurality of ports 106, and one or more internal windways (not shown in FIG. 1) that each connect at least subset of the ports 106. As the piston 110 moves up and down within the valve casing 120, one or more of the ports 106 can become aligned with, and create a pneumatic seal with, one or more openings in a side wall of the valve casing 120, which are in turn aligned with the airways 14 of the instrument 10. When such an alignment occurs, air that is blown through the airways 14 can enter through the one or more aligned ports 106, pass through the piston 110 via the internal windways, and resonate to produce sounds having a particular pitch and quality. Therefore, a user of the instrument 10 can produce sound by coordinating the blowing of air through the instrument 10 and the pressing down of the piston 110 within the valve casing 120. The geometry of the ports 106 and windways of the piston 110 can be designed to achieve particular pitches and sound quality.

As the piston 110 moves within the valve casing 120, the ports 106 of the piston 110 may move in and out of alignment with the airways 14, which in some implementations can lead to the build-up and sudden release of air pressure within the instrument 10 as the user blows through the mouthpiece 12. Some users may find this build-up and sudden release of air pressure to be uncomfortable, disruptive, or otherwise undesirable. To mitigate this issue, the piston 110 can optionally include one or more venting features 112, which allow air to escape from the airways 14 even when the ports 106 are not aligned with the airways 114. This can prevent the build-up and sudden release of air pressure within the airways 114, smoothing changes to the air pressure within the airways 114 and leading to a more comfortable user experience.

While the piston valve assembly 100 is described as an example, many variations to the piston valve assembly 100 are contemplated, including alternative placements of the spring 114 (e.g., to a position above the piston 110), alternative numbers and placement of ports 106, alternative numbers and configurations of tubes 14, alternative geometries of the piston 110 and valve casing 120 (including alternative cross-sectional shapes of the ports 106), alternative mounting mechanisms (e.g. welding, adhesives, etc.), alternative mounting structures (e.g., valve guides, washers, valve pads, valve caps, valve button felt, valve button pads, etc.), and more.

Traditionally, pistons used in piston valve assemblies (e.g., the piston 110 in the piston valve assembly 100) have been made using a complex process that involves many starting components (e.g., over 15 components, over 20 components, over 25 components, over 30 components, etc.) and many processing steps (e.g., over 50 steps, over 60 steps, over 75 steps, over 80 steps, etc.). For example, in an existing manufacturing process, pistons can be made by extruding nickel or nickel alloy tubes (although, in some implementations, other materials such as stainless steel, brass, or hard-chrome-plated materials are sometimes used). In this process, a first extruded tube serves as the exterior surface of the piston 110 and one or more additional extruded tubes are bent to form the windways of the piston 110. A top cap and a bottom cap are also manufactured for joining at the distal ends of the first extruded tube to serve as a top surface and bottom surface, respectively, of the piston 110. The port holes 106 are interpolated into the first extruded tube, and then the various separate components (e.g., the first extruded tube, the one or more additional extruded tubes, the top cap, the bottom cap, etc.) are joined using a brazing process. The resulting assembly is then processed on a lathe to make the outer surface of the subassembly more cylindrical, and a human may use a ball bearing to push material out of the windways and to keep the internal surfaces of the windways round. The entire assembly is then nickel plated and ground (e.g., using a centerless grinder) to make the outer surface of the assembly as close to cylindrical as possible. Then, honing and lapping processes are utilized to achieve a desired surface finish of the assembly. Along the way, one or more steps may be repeated (sometimes several times) to manufacture a satisfactory piston for use in a wind instrument (e.g., the wind instrument 10).

Existing methods of manufacturing pistons, such as the one described above, can present many challenges. Such methods often require substantial amounts of skilled human labor, sometimes from multiple individuals, and present many opportunities for the introduction of human-attributable errors and imperfections. As a result of the substantial amount of human labor and large number of components involved, existing processes can also be time-consuming and relatively expensive, costing as much as $50 to $250 per piston. Consequently, yields of usable pistons using existing manufacturing processes are often low, ranging from 30% to 90% depending heavily on the size and complexity of the given piston. The pistons produced using existing manufacturing methods may also be difficult to reliably reproduce, and may be affected by lower dimensional precision and cylindricity (e.g., with tolerances on the order of +/−0.002 inches of total runout) compared to the pistons described in further detail herein. Lower dimensional precision can result in the forming of less effective pneumatic seals between the piston 110 and the valve casing 120 as well as undesirable or unsmooth motion of the piston 110 within the valve casing 120.

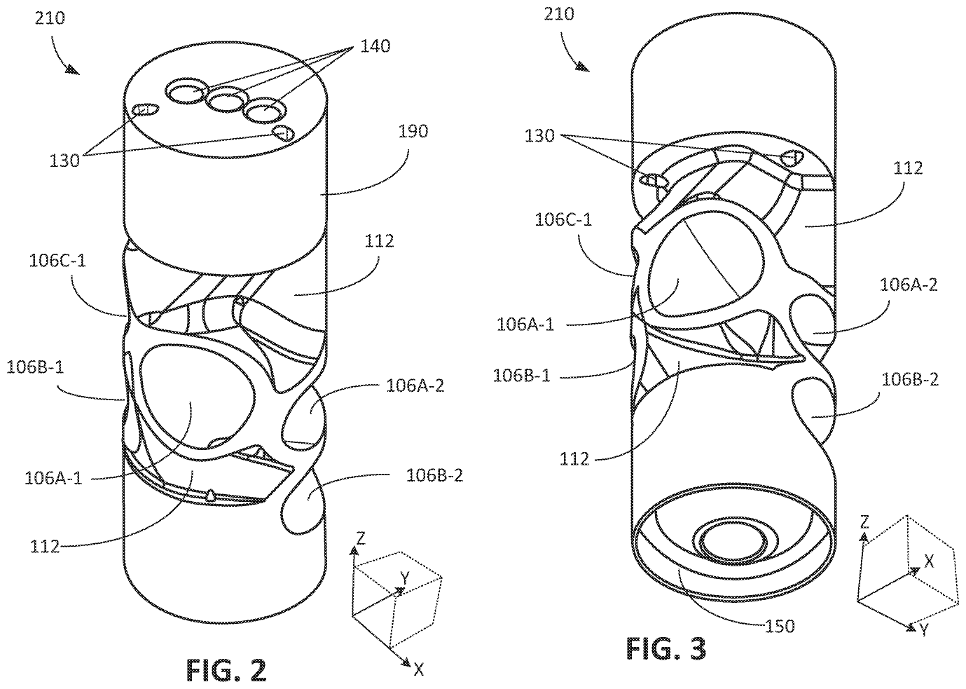

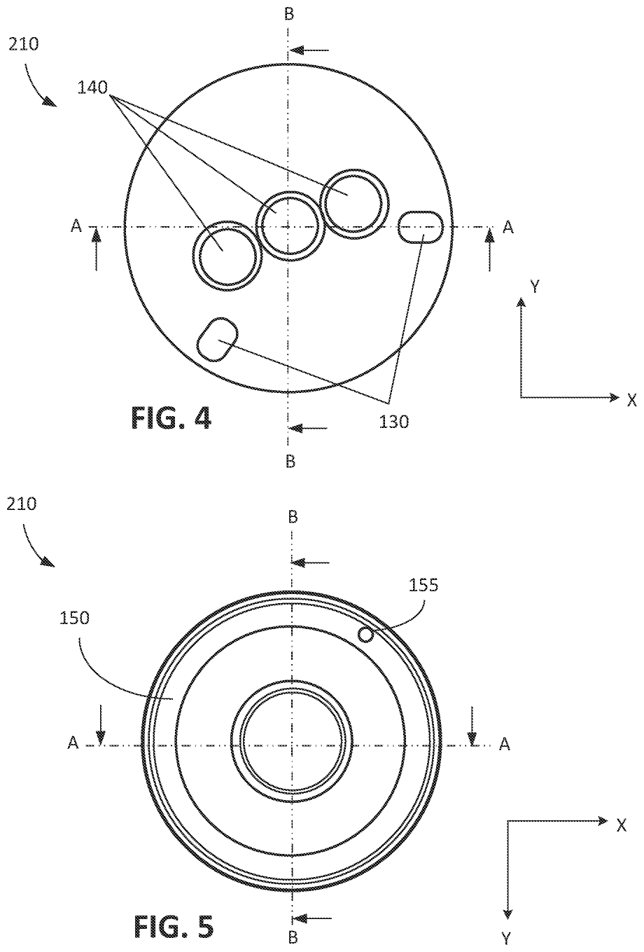

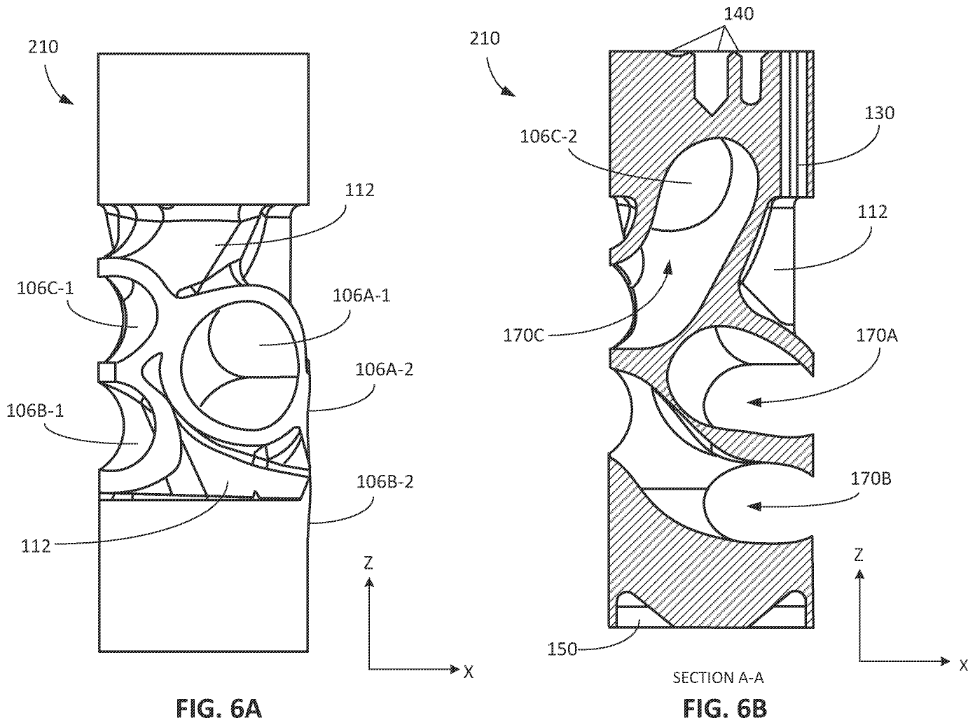

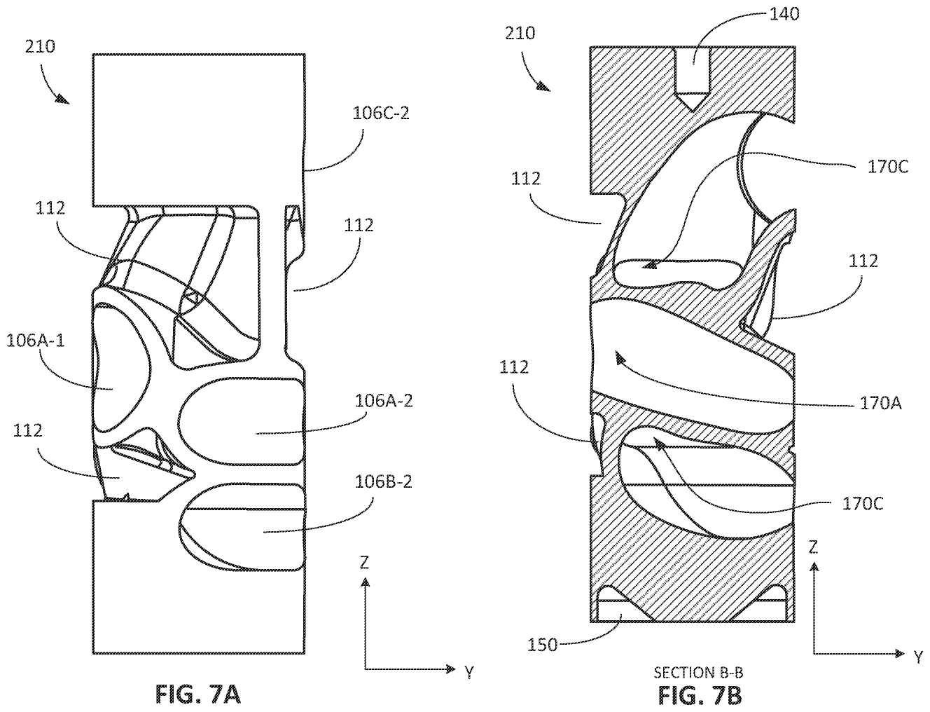

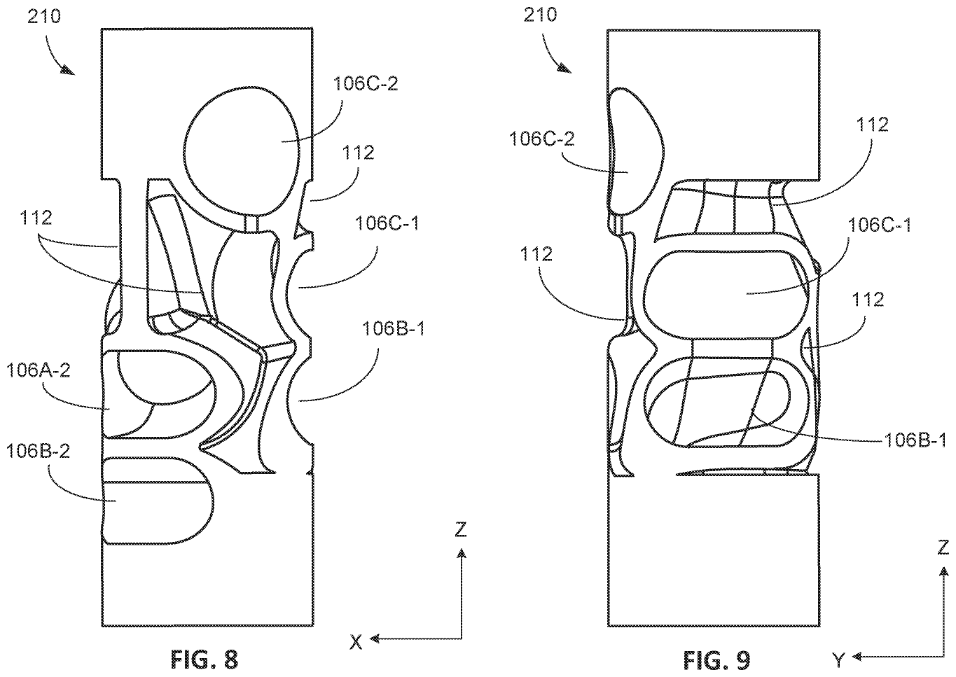

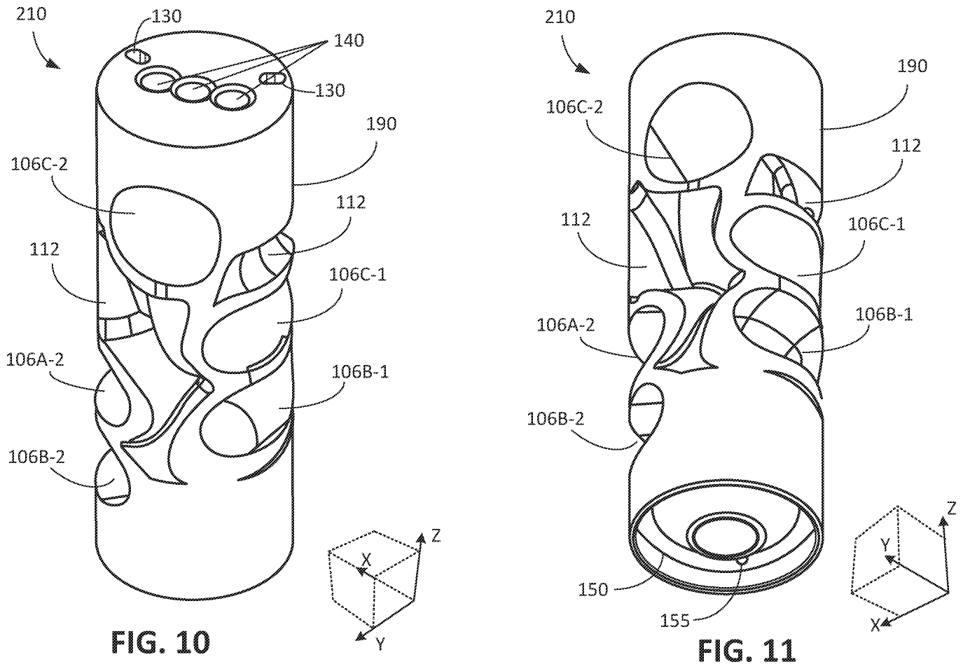

The technologies described herein include pistons and methods of manufacturing said pistons that can overcome many of the challenges of existing processes for making pistons for use in wind instruments. An example implementation of such a piston 210 is shown from various views in FIGS. 2-11. FIGS. 2 and 3 show front perspective views of the example piston 210 (from above and from below the piston 210, respectively). FIG. 4 shows a top view of the piston 210, and FIG. 5 shows a bottom view of the piston 210, with both figures indicating the cutting planes used to generate the cross-sectional views shown in FIG. 6B (corresponding to Section A-A) and FIG. 7B (corresponding to Section B-B). FIG. 6A shows a front view of the piston 210, FIG. 7A shows a view of the piston 210 from the right side, FIG. 8 shows a back view of the piston 210, and FIG. 9 shows a view of the piston 210 from the left side. FIGS. 10 and 11 show rear perspective views of the piston 210 (from above and from below the piston 210 respectively). While the piston 210 is described as an illustrative example, it is not intended to be limiting, and other implementations of pistons are contemplated as described in further detail herein.

The piston 210 includes many similar features to the schematically illustrated piston 110 shown in FIG. 1, and consequently, corresponding features are labeled similarly. The piston 210 is substantially cylindrical, including an outer surface 190 configured to serve as a journal bearing with a valve casing (e.g., the valve casing 120 shown in FIG. 1). The piston 210 includes three pairs of ports (collectively referred to as ports 106), with each pair of ports connected by a windway. However, in some implementations, windways may connect more than two ports (e.g., three ports, four ports, etc.). In the piston 210, a first pair of ports (ports 106A-1 and 106A-2) is connected by windway 170A; a second pair of ports (ports 106B-1 and 106B-2) is connected by windway 170B; and a third pair of ports (ports 160C-1 and 106C-2) is connected by windway 170C. In some implementations, the orientation and geometry of the ports 106 and windways 170A-170C can be designed to be reachable and machinable by a 5-axis CNC machine, a “3+2” turning and milling center (e.g., a DMG Mori NTX1000 with B-axis milling head), or various setups that provide 5-axes of cutting tool movement across multiple machines. In some implementations, a webbing surrounding a perimeter of each of the ports 106 can be designed to have a minimum thickness (e.g., ranging from 0.05 inches to 0.25 inches) to ensure a tight seal between the ports 106 and the tubes of a wind instrument (e.g., the tubes 14 of wind instrument 10).

The piston 210 further includes one or more venting features 112, which allow air to escape from airways of a wind instrument (e.g., the airways 14 shown in FIG. 1) when the ports 106 are not aligned with the airways. The venting features 112 can be recesses (relative to the outer surface 190) or carved out spaces (e.g., carved out by a CNC machine) that collect air and are pneumatically connected to an environment external to the piston 210 in order to allow the air to exit the piston 210. For example, each venting feature 112 can be pneumatically connected to the external environment via one or more through-holes of the piston 210 such as the through-holes 130 (allowing air to exit through a top surface of the piston 210) and the through-hole 155 (allowing air to exit through a bottom surface of the piston 210). Although the through-holes 130, 155 are labeled as separate features from the venting features 112, in some implementations, the through-holes 130, 155 can themselves be considered venting features. Furthermore, while the venting features 112 are described as providing venting capabilities to the piston 210, in some implementations, the venting features 112 can simultaneously provide additional advantages. For example, in addition to providing venting capabilities, the venting features 112 can also reduce a weight of the piston 210 and can be designed to achieve a desired piston weight. In such cases, the venting features 112 can also be referred to as “light-weighting features.” In some implementations, the geometry of the piston 210 and/or a surface finish (e.g., one or more surface roughness values) of the piston 210 can be advantageously achieved using a 5-axis CNC machine and/or a centerless grinder (e.g., more economically, more rapidly, etc.) compared to other approaches. However, it is contemplated that other types of machining, grinding, honing, and lapping could also be used to achieve similar results.

The piston 210 further includes additional features to adapt the piston 210 for use in a wind instrument. For example, a top surface of the piston 210 is substantially flat to serve as a mounting surface for additional components (e.g., a valve stem, valve button, valve guide, washer, valve pad, valve cap, valve button felt, valve button pad, etc.) and includes one or more (e.g., one, two, three, four, five, etc.) mounting holes 140. In some implementations, one or more of the mounting holes 140 can be threaded to receive a bolt or a screw. A bottom surface of the piston includes a recessed feature 150 configured to receive a spring (e.g., the spring 114 shown in FIG. 1). The recessed feature 150 can improve the ease of assembly of a piston valve assembly (e.g., the piston valve assembly 100) and can reduce the risk of the spring becoming displaced within the valve casing 120.

While the piston 210 is described as an example, many variations to the piston 210 are contemplated, including alternative placements of the recessed feature 150 (e.g., to a top surface of the piston 210), alternative numbers and placement of ports 106, alternative geometries of the piston 210, alternative mounting mechanisms (e.g. welding, adhesives, etc.), and more. In addition, as will be appreciated by those skilled in the art, in some implementations, one or more features can be optionally implemented such as the venting features 112; the through-holes 130, 155; the recessed feature 150; etc.

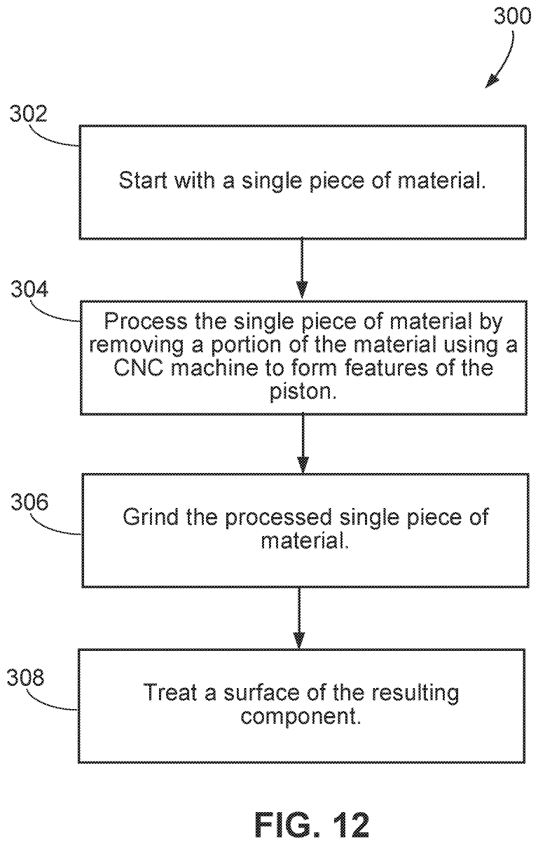

FIG. 12 shows an example process 300 for manufacturing pistons such as the piston 210. Using the process 300, the piston 210 can be manufactured from a single piece of material such as a cylindrical rod or bar stock of the material. In such implementations, the piston 210 can be referred to as a “one-piece piston.” Accordingly, operations of the process 300 can include starting with a single piece of material (302). In some implementations, the material can be a relatively lightweight and easily machinable metal such as aluminum, an aluminum alloy (e.g., aluminum 6020), or a magnesium alloy.

Operations of the process 300 also include processing the single piece of material by removing a portion of the material using a CNC machine (e.g., a 5-axis CNC machine) to form features of the piston (304). For example, the features of the piston 210 that are formed at operation 304 can include the ports 106; the windways 170A-170C; the venting features 112; the through-holes 130, 155; the mounting holes 140; and/or the recessed feature 150.

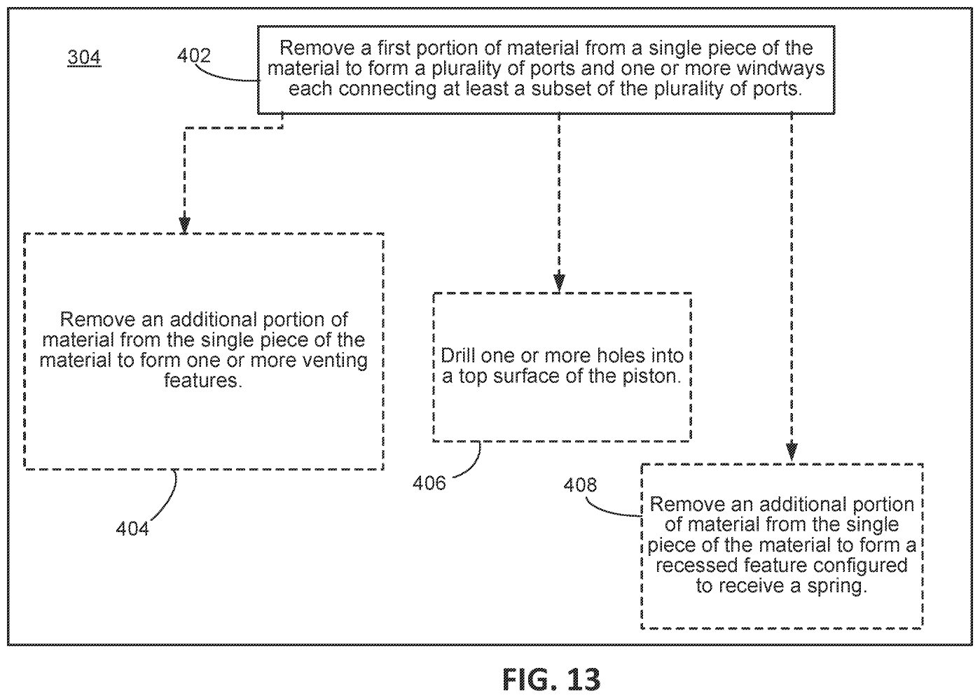

As shown in FIG. 13, the operation 304 can itself be a sub-process including multiple operations. For example, the operation 304 can include removing a first portion of material from a single piece of the material to form a plurality of ports and one or more windways each connecting at least a subset of the plurality of ports (402). Optionally, the operation 304 can also include removing an additional portion of material from the single piece of the material to form one or more venting features (404). The one or more venting features can be configured to smooth changes to an air pressure within one or more airways of the wind instrument as the piston moves within a casing of the wind instrument. For example, the one or more venting features can correspond to the venting features 112 and the one or more airways of the wind instrument can correspond to the airways 14 of the instrument 10. Optionally, the operation 304 can also include drilling one or more holes into a top surface of the piston. For example, the one or more holes can correspond to the mounting holes 140 and/or the through-holes 130. In some implementations, the mounting holes 140 can additionally be tapped to add threads and/or other holes can be drilled into the piston (e.g., the through-hole 155 at the bottom surface of the piston). Optionally, the operation 304 can also include removing an additional portion of material from the single piece of the material to form a recessed feature configured to receive a spring. For example, the recessed feature can correspond to the recessed feature 150 of the piston 210. In various implementations, the order of operations 402, 404, 406, and 408 can be interchangeable.

Referring again to FIG. 12, after processing the single piece of material (304), operations of the process 300 can also include grinding the processed single piece of material (306). For example, the processed single piece of material can be ground using a centerless grinder to achieve a more precise cylindrical outer surface 190 of the piston 210.

Operations of the process 300 can also include treating a surface of the resulting component (308). For example, treating the surface of the resulting component can include polytetrafluoroethylene (PTFE) (e.g., Teflon) sealing the surface to make the piston 210 self-lubricating. Treating the surface of the resulting component can also include hard coat anodizing the piston 210 to reduce the risk of corrosion at the interface between the piston 210 and a valve casing within which the piston 210 may later be installed. In some implementations, the polytetrafluoroethylene (PTFE) sealing and hard coat anodization can be performed simultaneously in a single process. In some implementations, treating the surface of the resulting component (308) can include other surface treatment processes including electroless nickel plating (alternatively or in addition to PTFE sealing and hard coat anodization), physical vapor deposition of a low-friction ceramic coating, zinc passivation (e.g., to reduce corrosion risk), etc.

Upon completion of the process 300, the resulting manufactured piston can be assembled into a piston valve assembly (e.g., the piston valve assembly 100) and installed for use in a wind instrument 10. The process 300 can provide many advantages compared to previously existing methods of making pistons for use in wind instruments. For example, the process 300 can be much less complex and much more automated than existing processes, resulting in higher yields, faster manufacturing times, lower costs, lower risk of human-attributable errors, and improved reproducibility. Furthermore, making the piston 210 from a single piece of solid rod rather than thin-wall tubes can enable shaping the final outer surface 190 of the piston 210 using a centerless grinder rather than using honing or lapping processes. Compared to honing or lapping processes, centerless grinding can have the advantage of achieving a higher precision of cylindricity (e.g., with tolerances of approximately 0.0002 inches). This higher precision can in turn result in smoother movement of the piston 210 within a valve casing of an instrument as well as better sealing of the ports 106 of the piston 210 with airways of the instrument.

Although machining pistons from a single piece of solid rod may require larger volumes of material per piston compared to extruded thin-wall tubes, the use of lightweight metals such as aluminum or aluminum alloys can compensate for the additional volume required, resulting in pistons having similar weight to existing pistons. The ability to match the weight of existing pistons can enable pistons produced by the process 300 to be readily interchangeable with existing pistons without substantially changing the sound of the instrument or a user experience while playing the instrument. While aluminum or aluminum alloys have previously been avoided for making pistons due, at least in part, to the risk of corrosion when in contact with brass (e.g., a brass valve casing), treating the surface of the piston via polytetrafluoroethylene (PTFE) (e.g., Teflon) sealing and/or hard coat anodization can minimize this risk.

In order to be interchangeable with existing pistons, pistons made using the process 300 may not only need to match the weight of existing pistons, but also one or more dimensions of existing pistons (e.g., a diameter of an outer surface, the placement and sizing of ports, the placement and sizing of mounting holes, etc.). The dimensional and weight specifications for such pistons can vary by instrument. For example, the piston 210 is described as an example and can be suitable for use in a Sousaphone. The piston 210 can weigh between 70 g and 110 g. The outer surface 190 of the piston can have a diameter between 1.0 inch and 1.5 inches (e.g., 1.22 inches), and can be machined with a tolerance of approximately 0.0002 inches. The height of the piston 210, from the bottom surface to the top surface, can be between 3.25 inches and 3.75 inches (e.g., 3.46 inches). The ports 106A-1 and 106C-2 can be circular ports having a diameter between 0.6 inches and 0.9 inches (e.g., 0.74 inches). The ports 106A-2, 106B-2, 106C-1, and 106B-1 can be elongated ports having a length between 0.8 inches and 1.0 inches (e.g., 0.92 inches) and a height between 0.4 inches and 0.6 inches (e.g., 0.5 inches). A minimum webbing thickness around the perimeter of the ports 106 can be between 0.05 inches and 0.25 inches (e.g., 0.15 inches). The mounting holes 140 can have diameter between 0.1 inches and 0.3 inches (e.g., 0.204 inches), can be between 0.2 inches and 0.4 inches (e.g., 0.29 inches) deep, can be chamfered (e.g., to include a 45 degree chamfer), and can be threaded with a 15/64″-32 USF tap. The through-holes 130 can have a width between 0.5 inches and 0.15 inches (e.g., 0.11 inches) and a radius of curvature between 0.02 inches and 0.10 inches (e.g., 0.06 inches). The through-hole 155 can have a radius between 0.01 and 0.05 inches (e.g., 0.3 inches). The recessed feature 150 can have an outer diameter between 1.0 inch and 1.3 inches (e.g., 1.14 inches), and a maximum depth between 0.1 inches and 0.3 inches (e.g., 0.2 inches). A surface of the venting features 112 can have a roughness average (Ra) that is greater than a roughness average of the ports 106 and windways 170A-170C. For example, in the piston 210, a roughness average of the venting features 112 can be approximately 100 microinches, while a roughness average of the ports 106 and windways 170A-170C can be approximately 30 microinches.

As would be understood by those skilled in the art, pistons used for other wind instruments can have different weight and/or dimensional requirements, but can be manufactured using a process similar to the process 300 and can be designed to include similar features to the piston 210. For example, a piston for a trumpet can be made to weigh 45 g to 60 g and have an outer surface with a diameter of 0.600 inches to 0.700 inches. A piston for a piccolo trumpet can be made to weigh 20 g to 35 g and have an outer surface with a diameter of 0.400 inches to 0.700 inches. A piston for a tuba can be made to weigh 90 g to 130 g and have an outer surface with a diameter of 0.900 inches to 1.400 inches. While these examples are illustrative, they are not intended to be limiting, and pistons for other wind instruments are contemplated.

Other embodiments and applications not specifically described herein are also within the scope of the following claims. Elements of different implementations described herein may be combined to form other embodiments not specifically set forth above. Elements may be left out of the structures described herein without adversely affecting their operation. Furthermore, various separate elements may be combined into one or more individual elements to perform the functions described herein.

What is claimed is:

1. A method of making a piston for a wind instrument, the method comprising:
removing a first portion of material from a single piece of the material to form a plurality of ports and one or more windways each connecting at least a subset of the plurality of ports.

2. The method of claim 1, wherein the single piece of the material comprises a cylindrical rod of the material.

3. The method of claim 1, wherein the material comprises aluminum, an aluminum alloy, brass, a nickel-copper alloy, or stainless steel.

4. The method of claim 1, further comprising hard coat anodizing a surface of the piston.

5. The method of claim 1, further comprising polytetrafluoroethylene (PTFE) sealing a surface of the piston.

6. The method of claim 1, wherein removing the first portion of material from the single piece of the material comprises removing the first portion of material from the single piece of the material using a computer numerical control (CNC) machine.

7. The method of claim 1, further comprising removing a second portion of material from the single piece of material to form one or more venting features configured to smooth changes to an air pressure within one or more airways of the wind instrument as the piston moves within a casing of the wind instrument.

8. The method of claim 1, further comprising drilling one or more mounting holes into a top surface of the piston.

9. The method of claim 1, further comprising removing a second portion of material from the single piece of material to form a recessed feature configured to receive a spring.

10. The method of claim 1, further comprising grinding an outer surface of the single piece of the material using a centerless grinder.

11. A piston for a wind instrument, the piston comprising:
a one-piece body, the one-piece body defining:
a plurality of ports; and
one or more windways each connecting at least a subset of the plurality of ports,
wherein the plurality of ports and the one or more windways are formed by processing a single piece of a material to remove a portion of the material from the single piece.

12. The piston of claim 11, wherein the single piece of the material comprises a cylindrical rod of the material.

13. The piston of claim 11, wherein the one-piece body is made of aluminum, an aluminum alloy, brass, a nickel-copper alloy, or stainless steel.

14. The piston of claim 11, wherein a surface of the piston is hard coat anodized.

15. The piston of claim 11, wherein a surface of the piston is polytetrafluoroethylene (PTFE) sealed.

16. The piston of claim 11, wherein processing the single piece of the material to remove the portion of the material from the single piece comprises removing the portion of the material using a computer numerical control (CNC) machine.

17. The piston of claim 11, wherein the piston is configured to fit within a casing of the wind instrument and is further configured to move translationally along a longitudinal axis of the casing when fit within the casing.

18. The piston of claim 17, comprising one or more venting features configured to smooth changes to an air pressure within one or more airways of the wind instrument as the piston moves translationally along the longitudinal axis of the casing.

19. The piston of claim 18, wherein the one-piece body defines the one or more venting features.

20. The piston of claim 11, wherein the wind instrument is a trumpet, a French horn, a tuba, a euphonium, a cornet, a flugelhorn, a mellophone, a trombone, a valve trombone, a baritone, a marching brass instrument, a sousaphone, a piccolo trumpet, or a novel valved brass instrument.

21. The piston of claim 11, comprising a substantially flat top surface, wherein the top surface comprises one or more mounting holes.

22. The piston of claim 11, comprising a bottom surface that includes a recessed feature configured to receive a spring.

23. A wind instrument comprising:
one or more tubes configured to transport air moved by a user of the wind instrument;
a valve casing, wherein a side wall of the valve casing comprises one or more openings aligned with the one or more tubes; and
a piston disposed within the valve casing, the piston comprising:
a one-piece body, the one-piece body defining:
a plurality of ports, and
one or more windways each connecting at least a subset of the plurality of ports,
wherein the plurality of ports and the one or more windways are formed by processing a single piece of a material to remove a portion of the material from the single piece.

24. The wind instrument of claim 23, wherein the single piece of the material comprises a cylindrical rod of the material.

25. The wind instrument of claim 23, wherein the one-piece body is made of aluminum, an aluminum alloy, brass, a nickel-copper alloy, or stainless steel.

26. The wind instrument of claim 23, wherein a surface of the piston is hard coat anodized.

27. The wind instrument of claim 23, wherein a surface of the piston is polytetrafluoroethylene (PTFE) sealed.

28. The wind instrument of claim 23, wherein processing the single piece of the material to remove the portion of the material from the single piece comprises removing the portion of the material using a computer numerical control (CNC) machine.

29. The wind instrument of claim 23, wherein the piston is configured to move translationally along a longitudinal axis of the valve casing to align one or more ports of the plurality of ports with the one or more openings of the side wall of the valve casing.

30. The wind instrument of claim 29, wherein the piston comprises one or more venting features configured to smooth changes to an air pressure within the one or more tubes as the piston moves translationally along the longitudinal axis of the valve casing.

31. The wind instrument of claim 30, wherein the one-piece body defines the one or more venting features.

32. The wind instrument of claim 23, wherein the wind instrument is a trumpet, a French horn, a tuba, a euphonium, a cornet, a flugelhorn, a mellophone, a trombone, a valve trombone, a baritone, a marching brass instrument, a sousaphone, a piccolo trumpet, or a novel valved brass instrument.

33. The wind instrument of claim 23, wherein the piston comprises a substantially flat top surface, wherein the top surface comprises one or more mounting holes.

34. The wind instrument of claim 23, wherein the piston comprises a bottom surface that includes a recessed feature configured to receive a spring.
